(19) United States
(12) Patent Application Publication
(10) Pub. No.: US 2018/0322413 A1
(43) Pub. Date: Nov. 8, 2018

(54) NETWORK OF AUTONOMOUS MACHINE LEARNING VEHICLE SENSORS

(71) Applicant: T-Mobile USA, Inc., Bellevue, WA (US)

(72) Inventors: Eric Yocam, Bellevue, WA (US); Ahmad Arash Obaidi, Bellevue, WA (US)

(21) Appl. No.: 15/589,768

(22) Filed: May 8, 2017

(51) Int. Cl. G06N 99/00; G07C 5/08

(52) U.S. Cl. CPC G06N 99/005; G07C 5/085

(57) ABSTRACT

An input system includes one or more sensor devices that communicate via a local network and collect sensor data, which may be processed by a machine learning model to identify patterns in the data and recognize unusual conditions or potential safety issues. Sensor data may be processed by individual sensor devices having sufficient processing resources, or may be offloaded to a local or remote processor. Notifications may be generated with regard to safety issues, and user input may be received that indicates whether to treat a newly recognized pattern as a problem requiring corrective action, a one-time occurrence, or a pattern to be added to a list of known patterns. Sensor devices may collect data both within and outside the vehicle, and may communicate with in-vehicle systems, mobile computing devices, or other computing devices.

### BACKGROUND

Generally described, vehicles may be equipped with various systems for the safety and comfort of the driver and passengers, such as seat belts, airbags, anti-lock brakes, rear-view cameras, climate controls, navigation systems, audio or video entertainment systems, and the like. Such systems may provide a general level of protection for any driver or passenger in the vehicle, and may provide vehicle occupants with controls for selecting a preferred radio station, seat position, temperature, or other amenities that improve the travel experience.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram of an illustrative network topology that includes a vehicle containing autonomous sensor devices, a mobile computing device, and a networked computing device communicating with each other via a network.

FIGS. 2A-2D are pictorial drawings of illustrative user interfaces displaying alerts and notifications that are generated by an input system in accordance with aspects of the present disclosure.

FIG. 3 is an illustrative functional block diagram of an autonomous sensor device that implements aspects of the present disclosure.

FIG. 4 is a flow diagram of an illustrative sensor data aggregation routine implemented in accordance with aspects of the present disclosure.

FIG. 5 is a flow diagram of an illustrative sensor data processing routine implemented in accordance with aspects of the present disclosure.

### DETAILED DESCRIPTION

Generally described, aspects of the present disclosure relate to sensor systems. More specifically, aspects of the present disclosure relate to computing devices that collect, aggregate, and analyze sensor data using machine learning models. In other aspects, the present disclosure is directed to identifying and reporting anomalous patterns. In still further aspects, the present disclosure is directed to systems for taking corrective action in response to patterns that are determined to be abnormal or unsafe. Illustratively, a vehicle, such as a car, truck, bus, motorcycle, taxi, boat, aircraft, or other conveyance may include a number of sensor devices, which may collect sensor data regarding conditions in and outside the vehicle. For example, a device may collect sensor data from a motion sensor that detects people, animals, or objects approaching the vehicle. As further examples, a device may collect sensor data from a pressure plate installed in or under a seat of the vehicle, a camera that takes images or video of the vehicle's interior or exterior, a microphone or other audio sensor, a temperature sensor, a geolocation sensor (e.g., a GPS receiver), or other environmental sensor or sensors. One or more of the vehicle sensors may be designed or configured as a vehicle sensor system. Other vehicle sensors may be designed or configured for alternative or additional purposes, such as a general purpose camera or an output system for various types of audio data. The set of sensor devices utilized in the collection of sensor data can be generally referred to as an “input system.”

As described above, the sensor devices forming the input system may be equipped to collect sensor data. The sensor devices may further be equipped to transmit sensor data to other devices for processing. Alternatively, the sensor devices may have additional processing resources to process the collected sensor data, at least in part, and to aggregate data from other sensor devices and process it using a machine learning model. In some embodiments, the sensor devices may communicate with one another via a wired or wireless network, and may use communications protocols such as Z-wave, ZigBee, Wi-Fi, LTE, Bluetooth, Ethernet, TCP/IP, and the like. In further embodiments, individual sensor devices may communicate with each other regarding the resources (e.g., processing power, memory, bandwidth, etc.) that they can each make available for processing of sensor data. The sensor devices may collectively identify a “lead” sensor device that will aggregate sensor data (or aggregate the outputs of machine learning models executed by other sensor devices), and some or all of the other sensor devices may offload data processing to the lead sensor device. In other embodiments, the sensor devices may offload data processing to a dedicated processor on a local network or a processor on a remote network. In further embodiments, the roles of the sensor devices relative to each other may change dynamically. For example, a mobile computing device may join the local network, and may have processing capabilities that exceed the capabilities of the lead sensor device. The mobile computing device may therefore take over from the lead sensor device, and may perform aggregating and processing functions for the network of sensor device. The mobile computing device may then leave the local network, and the formerly identified lead sensor device may resume performing these functions.

Illustratively, one or more machine learning models can be implemented to process the sensor data to determine defined outcomes. Illustratively, a machine learning model may be trained to recognize various patterns in the sensor data. For example, a machine learning model may be configured to receive sensor data from a pressure plate under the driver's seat of a vehicle, an image of a person's face from a camera that is focused on the vehicle's interior, a mobile computing device identifier (e.g., a Bluetooth ID or MAC address), and geolocation data corresponding to a location. The machine learning model may be trained to identify a particular driver of the vehicle by identifying a pattern in the sensor data that corresponds to specific drivers or to distinguish drivers from passengers. The machine learning model may thus be used to distinguish between different drivers or passengers based on variations in the sensor data. In some embodiments, machine learning models may be trained on particular data sets, such as voice audio or images that include facial features.

Illustratively, patterns identified by the machine learning model may correspond to individual drivers or passengers, traffic conditions (e.g., a vehicle that is tailgating, approaching too closely, approaching too quickly, and so forth), pedestrians, emergency vehicles, driving patterns (e.g., commuting to work or driving to a frequent destination), collisions, carjacking attempts, or other road, traffic, or vehicle conditions. In some embodiments, patterns may be classified into known, safe, or normal patterns as well as unknown, unsafe, or abnormal patterns, and the input system may take different actions depending on the pattern classification. For example, the input system may alert an owner of the vehicle when it detect unsafe or unusual activity, or (as described in detail below) may take actions such as throttling or stopping the engine, reporting the vehicle stolen, or sending a message to a driver of the vehicle.

Although the present disclosure makes reference to input systems and autonomous sensor devices installed in vehicles, it will be understood that the present disclosure is not limited to vehicle-based systems. For example, the autonomous sensor devices described herein may be installed in a fixed location, such as a nursery, hospital, bank, vault, or supply room, and may identify patterns of sensor data relating to, e.g., persons entering and leaving the location or accessing particular services or areas at the location. As further examples, autonomous sensor devices may be installed in a desk, filing cabinet, dresser, table, or other article of furniture. One skilled in the art will thus appreciate that the disclosures relating to vehicles herein are for purposes of example and are not limiting.

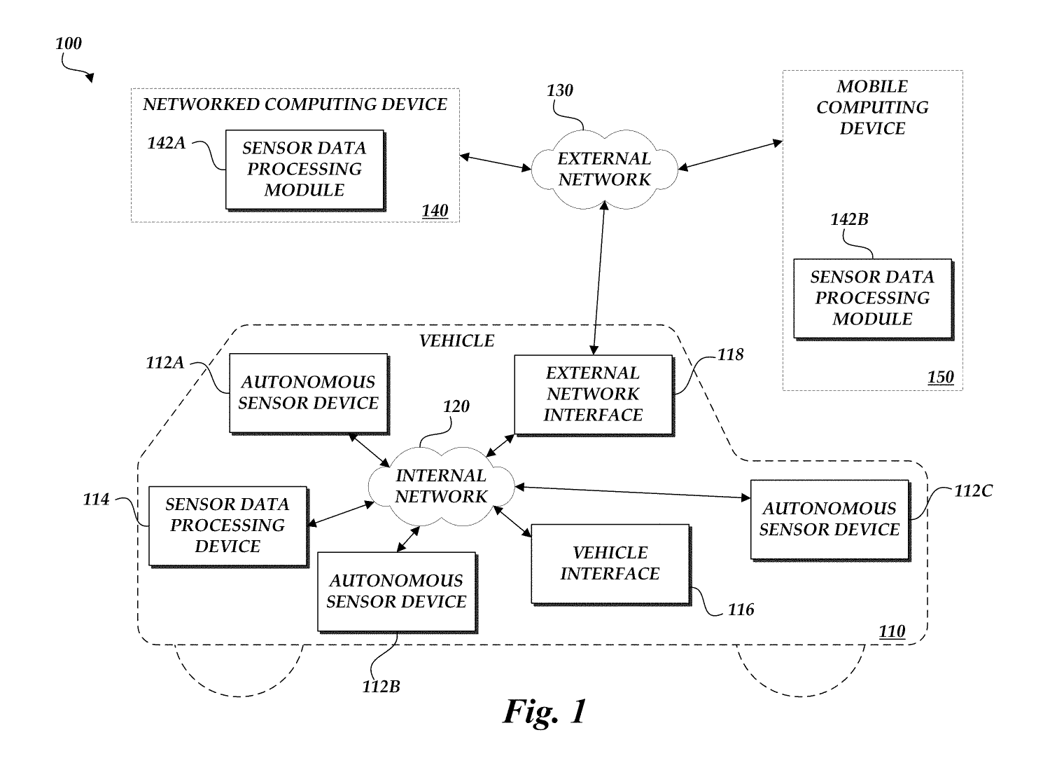

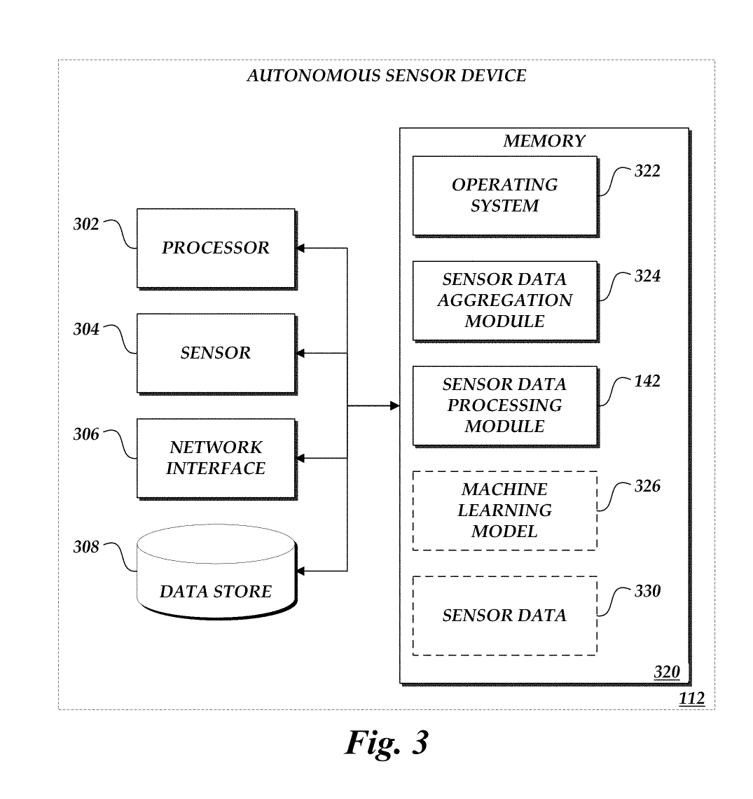

FIG. 1 is a block diagram of an exemplary network environment 100 for implementing aspects of the present disclosure. The network environment 100 may include a vehicle 110, which is equipped with autonomous sensor devices 112A-C. The autonomous sensor devices 112A-C are described in more detail below with reference to FIG. 3. The vehicle 110, in some embodiments, may further include a sensor data processing device 114. In some embodiments, the sensor data processing device 114 may be implemented as a component or components of an autonomous sensor device 112A, 112B, or 112C. In other embodiments, the sensor data processing device 114 may be implemented as a separate computing device.

The autonomous sensor devices 112A-C may communicate with each other or the sensor data processing device 114 via an internal network 120. The internal network may illustratively be any wired or wireless network that enables communication between the respective devices. For example, the internal network 120 may be a wireless network that implements a communications protocol such as Z-Wave, ZigBee, WiFi, Bluetooth, LTE, GPRS, TCP/IP, UDP, Ethernet, or other such protocols. In some embodiments, the internal network 120 may be omitted, and devices in the vehicle 110 may communicate with each other via an external network 130.

The vehicle 110 may further include a vehicle interface 116, which enables communication between the autonomous sensor devices 112A-C, the sensor data processing device 114, and vehicle systems such as in-dash displays, climate controls, audio or video entertainment systems, alarm systems, door and window locks, ignition systems, throttles and/or speed governors, and the like. In some embodiments, the vehicle 110 may further include an external network interface 118, which enables communications between devices in the vehicle 110 and external devices such as a networked computing device 140 or a mobile computing device 150. It will be understood that references to the mobile computing device 150 as an “external” device include embodiments in which the mobile computing device 150 is internal to the vehicle. In some embodiments, the mobile computing device 150 may communicate with autonomous sensor devices 112A-C, sensor data processing device 114, and/or vehicle interface 116 via the internal network 120.

It will be understood that the devices and interfaces 112A-C, 114, 116, and 118 may be combined or separated in various ways within the scope of the present disclosure. For example, the sensor data processing device 114, vehicle interface 116, and/or the external network interface 118 may be implemented as a single device or across multiple devices. As a further example, multiple sensor data processing devices 114 may be provided and may process sensor data from various groups of autonomous sensor devices 112A-C. Still further, the functions of the sensor data processing device 114 may be implemented within one or more autonomous sensor devices 112A-C. One skilled in the art will thus appreciate that the embodiment depicted in FIG. 1 is provided for purposes of example and is not limiting.

The external network interface 118 may enable communications via an external network 130. Illustratively, the external network 130 may be any wired or wireless network, including but not limited to a local area network (LAN), wide area network (WAN), mesh network, cellular telecommunications network, the Internet, or any other public or private communications network or networks. In some embodiments, the external network interface 118 may utilize protocols such as Z-Wave, Zigbee, WiFi, Bluetooth, LTE, GPRS, TCP/IP, UDP, Ethernet, or other protocols to communicate via the external network 130. Additionally, in some embodiments, the internal network 120 and the external network 130 may be the same network. It will further be understood that the external network 130 may refer to a network that is both within and outside the vehicle 110, and thus the “external” network 130 may enable communication between devices in and outside of the vehicle 110.

The vehicle 110 may thus communicate with external devices such as a networked computing device 140, which may include a sensor data processing module 142A that receives and processes sensor data at a remote location from the vehicle 110. The networked computing device 140 may generally be any computing device that communicates via the external network 130 and implements aspects of the present disclosure as described herein. In some embodiments, the networked computing device 140 may be equipped with its own remote sensor data processing device 114 and/or a network interface (not depicted in FIG. 1) that corresponds to the external network interface 118 of the vehicle 110. In other embodiments, the networked computing device 140 may be a different combination of hardware and/or software components.

The vehicle 110 may further communicate with a mobile computing device 150. Examples of a mobile computing device 150 include, but are not limited to, a cellular telephone, smartphone, tablet computing device, wearable computing device, electronic book reader, media playback device, personal digital assistant, gaming device, or other such devices. In some embodiments, as described above, one or more of the autonomous sensor devices 112A-C may generate sensor data regarding the mobile computing device 150. For example, an autonomous sensor device 112A may detect an identifier transmitted by the mobile computing device 150, such as a MAC address, International Mobile Subscriber Identity (IMSI), RFID code, or other identifier. As further described above, in some embodiments, the mobile computing device 150 may at various times be inside or outside the vehicle 110, and may change whether and how it communicates with the vehicle 110 based on its proximity. For example, the mobile computing device 150 may receive communications via the external network 130 when distant from the vehicle 110, and may receive communications via the internal network 120 when it is in or near the vehicle 110.

The mobile computing device 150, in some embodiments, may include a sensor data processing module 142B. Illustratively, the sensor data processing module 142B may include hardware and/or software components that implement aspects of the present disclosure. For example, the sensor data processing module 142B may be a software application executing on the mobile computing device 150, a component of an application or an operating system of the mobile computing device 150, a dedicated hardware element of the mobile computing device, or a combination of these components. In some embodiments, the sensor data processing modules 142A and 142B may have common architectures or components. In other embodiments, the modules 142A and 142B may provide similar functions, but have distinct architectures or implementations.

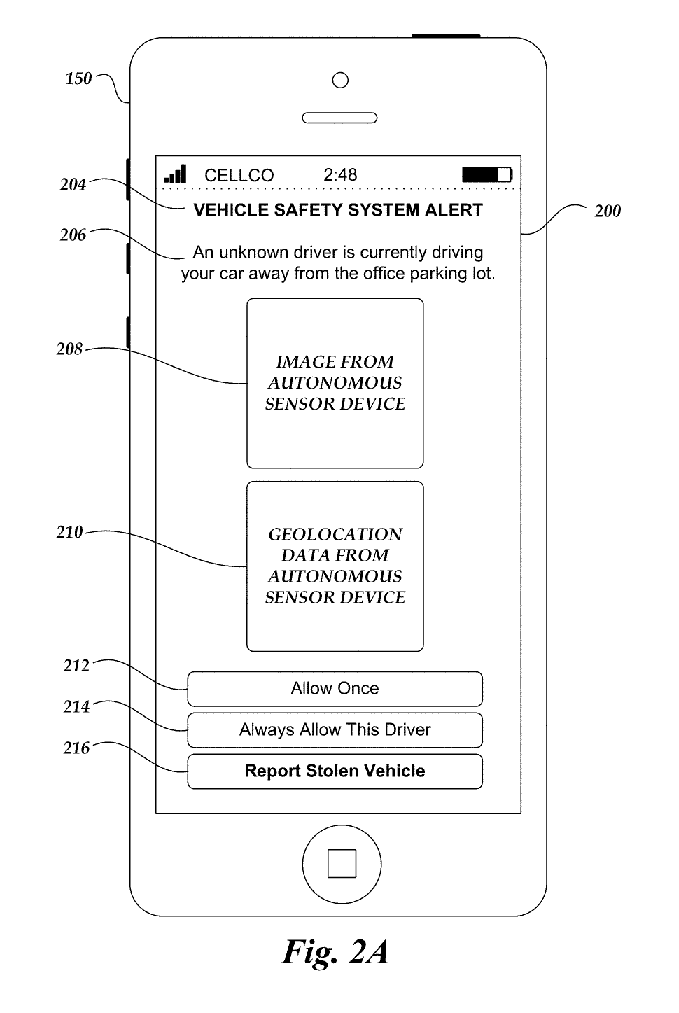

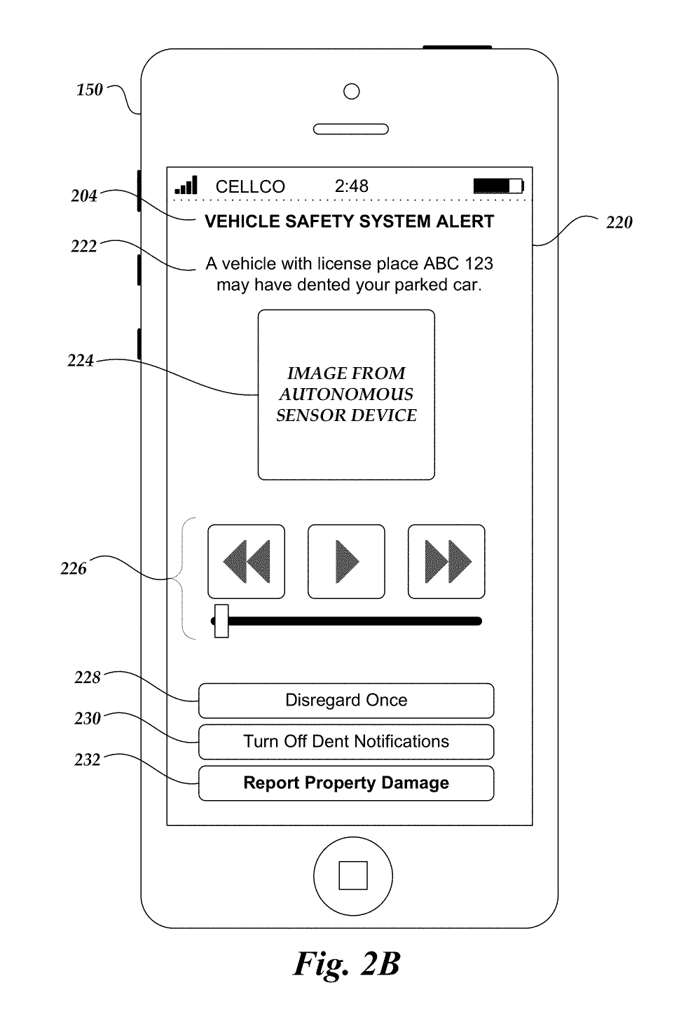

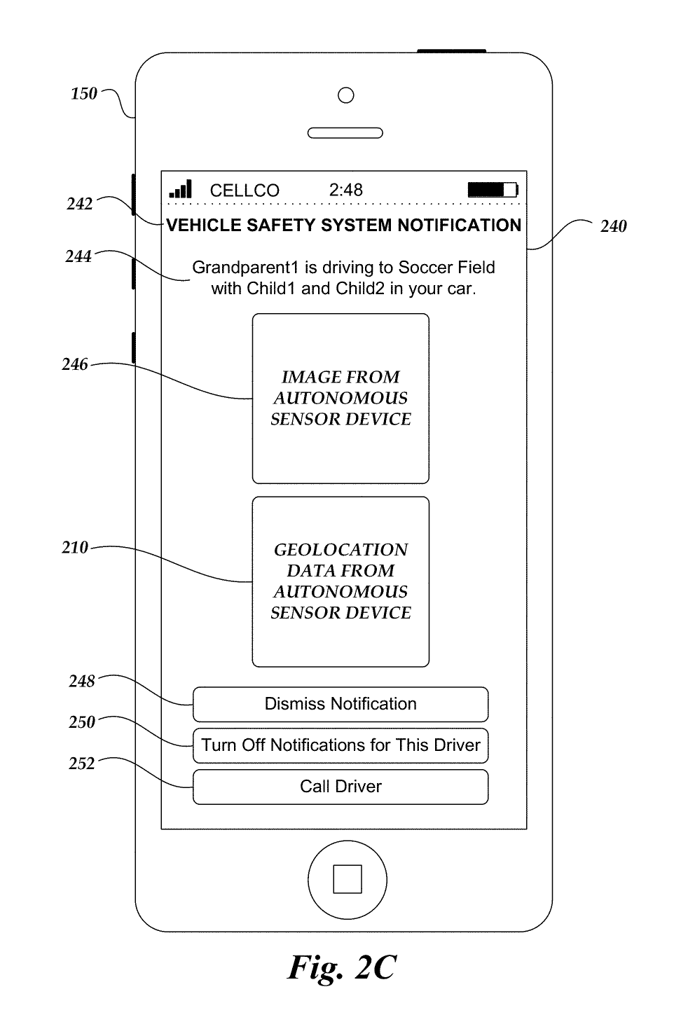

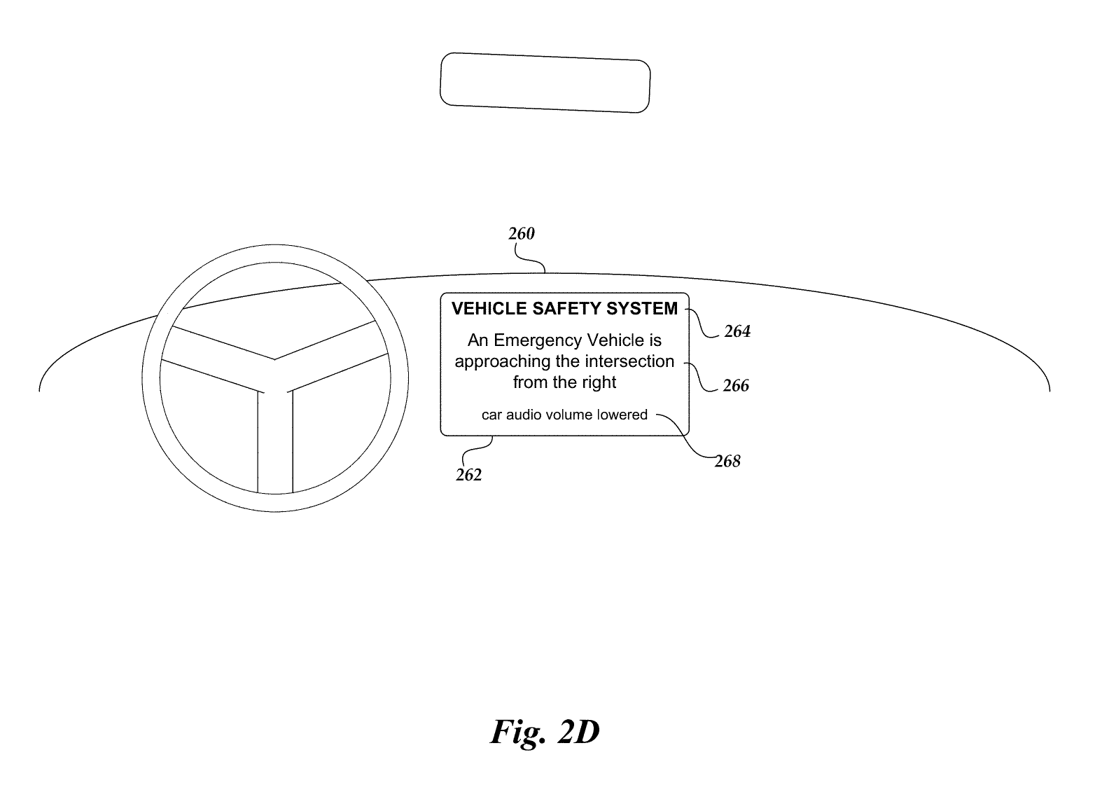

FIG. 2A is a pictorial drawing of an illustrative user interface 200 that displays an alert message on the mobile computing device 150. The user interface 200 includes a message title 204 and message description 206, which indicate to a user of the mobile computing device 150 that the input system has detected an unknown driver. As described in more detail below, the input system may determine that a driver is unknown based on sensor data including the driver's facial features, height, weight, other details of the driver's visual appearance, the date and/or time at which the vehicle is being driven, or other information.

The user interface 200 further displays an image 208, which may be an image of the driver that is captured by a sensor device (such as the autonomous sensor device 112A of FIG. 1). In some embodiments, the image 208 may be a video, and in further embodiments may include real-time or near-real-time information from one or more sensor devices. the user interface 200 further displays geolocation data 210 from another sensor device. Illustratively, the geolocation data 210 may include a map display indicating a current location of the vehicle 110, a direction of travel, a distance traveled, a route traveled, a time at which travel began, or other such information.

The user interface 200 further displays input buttons 212, 214, and 216, which may be utilized by a user of the mobile computing device 150 to indicate how the input system should treat the unknown driver. For example, the “allow once” button 212 may be used to indicate that the unknown driver has permission to drive the vehicle on this occasion, but does not generally have permission to drive, and thus the input system should generate another alert message if it detects the unknown driver in the future. The “always allow” button 214 may be used to indicate that the unknown driver should be added to a list of known drivers, and that the input system should not generate alerts when this person is driving the vehicle. And, the “report stolen vehicle” button 216 may be used to indicate that the unknown driver does not have permission to operate the vehicle. The input system may take a number of actions in response to the indication that the unknown driver does not have permission. For example, the input system may report to law enforcement that the vehicle has been stolen, disable the vehicle (e.g., by shutting off the engine remotely), track the vehicle's location, trigger an alarm on the vehicle, store sensor data associated with the unauthorized use of the vehicle, transmit the sensor data, or notify an insurance provider.

It will be understood that the user interface 200 is provided for purposes of example, and that variations on the user interface 200 are within the scope of the present disclosure. For example, any of the elements 204-216 may be omitted. As a further example, the user interface 200 may be presented in the form of a text message, multimedia message, audio message, voice message, notification delivered via the operating system, badge or other indication on an application icon, or other format. It will also be understood that, although depicted as a smartphone in FIGS. 2A-2C, embodiments of the mobile computing device 150 include other form factors and interfaces.

FIG. 2B is a pictorial drawing of an illustrative user interface 220 that displays a different alert message on the mobile computing device 150. In FIG. 2B, the alert title 204 is as described in FIG. 2A, and the alert description 222 indicates that the input system has detected sensor data consistent with exterior damage to the vehicle. For example, the sensor data processed by the input system may have included images from an external camera showing another vehicle approaching the vehicle 110, motion sensor data indicating lateral movement of the vehicle 110, and audio data from an external microphone. As described below, the input system may process these sensor data using a machine learning model, identify a pattern, and determine that the pattern represents an abnormal condition, such as a collision. The user interface 220 may include an image 224 (or, in some embodiments, video) from the external camera, which may include a license plate or other information regarding the approaching vehicle. The user interface 220 may further include audio playback controls 226, which may be utilized by a user of the mobile computing device 150 to play audio data associated with the collision.

The user interface 220 may further include buttons 228, 230, and 232, which allow the user of the mobile computing device 150 to indicate whether or how the input system should respond to the detected pattern. The “disregard once” button 228 may be utilized to instruct the system that the detected pattern should be disregarded. The “turn off dent notifications” button 230 may be utilized to instruct the system that the detected pattern and any other patterns that the system identifies as a potential collision should be disregarded, and the “report property damage” button 232 may be utilized to instruct the system to perform a corrective action, such as notifying an insurance company or storing the sensor data associated with the collision.

FIG. 2C is a pictorial drawing of an illustrative user interface 240 that displays a notification message on the mobile computing device 150. In the user interface 240, the notification title 242 indicates a lower-priority notification rather than an alert. In some embodiments, the notification message may be displayed in a different format than an alert, or may be displayed in a different manner. For example, a notification may be displayed as a background or temporary message, while an alert may require that the user interact with it before it is dismissed. The notification description 244 identifies three occupants of the vehicle 110, and indicates that authorized driver Grandparent1 is taking passengers Child1 and Child2 to soccer practice. The notification message may further include an appointment calendar 246 or other information regarding a scheduled activity. In some embodiments, the input system may obtain appointment calendar information or other data from the mobile computing device 150, and may analyze calendar information as part of its assessment of whether a particular pattern of sensor data is anomalous.

The user interface 240 may further include buttons 248, 250, and 252, which may allow the user of the mobile computing device 150 to dismiss the notification, turn off notifications regarding Grandparent1, and place a phone call to Grandparent1, respectively. In various embodiments, the user interface 240 may provide other controls that allow the user to perform various functions. For example, the user interface 240 may provide “do not disturb” controls that allow turning off notifications for a duration (e.g., an hour) or a time period (e.g., business hours). As further examples, the user interface 240 may provide controls that enable communication with passengers (e.g., with Child1 and/or Child2), enable forms of communication other than a phone call (e.g., text messaging), or other controls.

Various embodiments of the input system may generate other user interfaces similar to those depicted in FIGS. 2A-2C. As examples, user interfaces may be generated that display notifications or alerts when an authorized driver exceeds a safe speed while driving, takes the vehicle 110 outside a specified geographic region, takes the vehicle 110 outside a learned geographic region, takes an unusual route to a destination, decelerates abruptly, or has a traffic accident; when an unknown passenger enters the vehicle; when an unknown person approaches or touches the vehicle; or when other patterns in the sensor data are identified and determined to be unusual or unsafe.

FIG. 2D is a pictorial drawing of an illustrative user interface 262 displayed on an in-dash display panel of a vehicle dashboard 260. In some embodiments, the input system may interact with a vehicle interface, such as the vehicle interface 116 of FIG. 1, in order to display the user interface 262 or other information on a vehicle dashboard 260. In the illustrated embodiment, the user interface 262 includes a message title 264 and a message content 266, which indicates that the input system has determined from the sensor data that an emergency vehicle is approaching from the right. For example, the input system may collect sensor data including an approaching siren, flashing lights, and/or indications that other vehicles are pulling to the side of the road, and may use a machine learning model on the sensor data to determine that these data are consistent with the approach of an emergency vehicle.

The user interface 262 may further include an informational message 268, indicating that the input system has automatically lowered the volume of the vehicle's audio entertainment system so that the driver can hear the approaching emergency vehicle. In some embodiments, the user interface 262 may additionally display a street map, arrow, or other symbol indicating the location of the approaching emergency vehicle or the direction from which it is approaching.

In some embodiments, as described above, the input system may interact with other vehicle systems via the vehicle interface 116. For example, the input system may adjust climate controls, entertainment systems (e.g., preferred volume, radio stations, audio channels, media files, etc.), seat adjustments, fuel economy modes, or other vehicle settings or preferences in response to detecting a known driver or passenger. The input system may thus improve the user experience with the vehicle as well as providing increased safety and protection.

FIG. 3 is an illustrative block diagram depicting a general architecture of an autonomous sensor device 112, which includes an arrangement of computer hardware and software that may be used to implement aspects of the present disclosure. The autonomous sensor device 112 may include more (or fewer) elements than those displayed in FIG. 3. It is not necessary, however, that all of these elements be shown in order to provide an enabling disclosure.

As illustrated, the autonomous sensor device 112 includes a processor 302, a sensor 304, a network interface 306, and a data store 308, all of which may communicate with one another by way of a communication bus. The network interface 306 may provide connectivity to one or more networks (such as internal network 120 or external network 130) or computing systems and, as a result, may enable the autonomous sensor device 112 to receive and send information and instructions from and to other computing systems or services, such as other autonomous sensor devices 112, a sensor data processing device 114, a networked computing device 140, or a mobile computing device 150. In some embodiments, as described above, the autonomous sensor device 112 may be configured to receive and process sensor data from other autonomous sensor devices 112, or may be configured to send unprocessed sensor data to another autonomous sensor device 112 for processing.

The processor 302 may also communicate to and from a memory 320. The memory 320 may contain computer program instructions (grouped as modules or components in some embodiments) that the processor 302 may execute in order to implement one or more embodiments. The memory 320 generally includes RAM, ROM, and/or other persistent, auxiliary, or non-transitory computer-readable media. The memory 320 may store an operating system 322 that provides computer program instructions for use by the processor 302 in the general administration and operation of the autonomous sensor device 112. The memory 320 may further store specific computer-executable instructions and other information (which may be referred to herein as “modules”) for implementing aspects of the present disclosure.

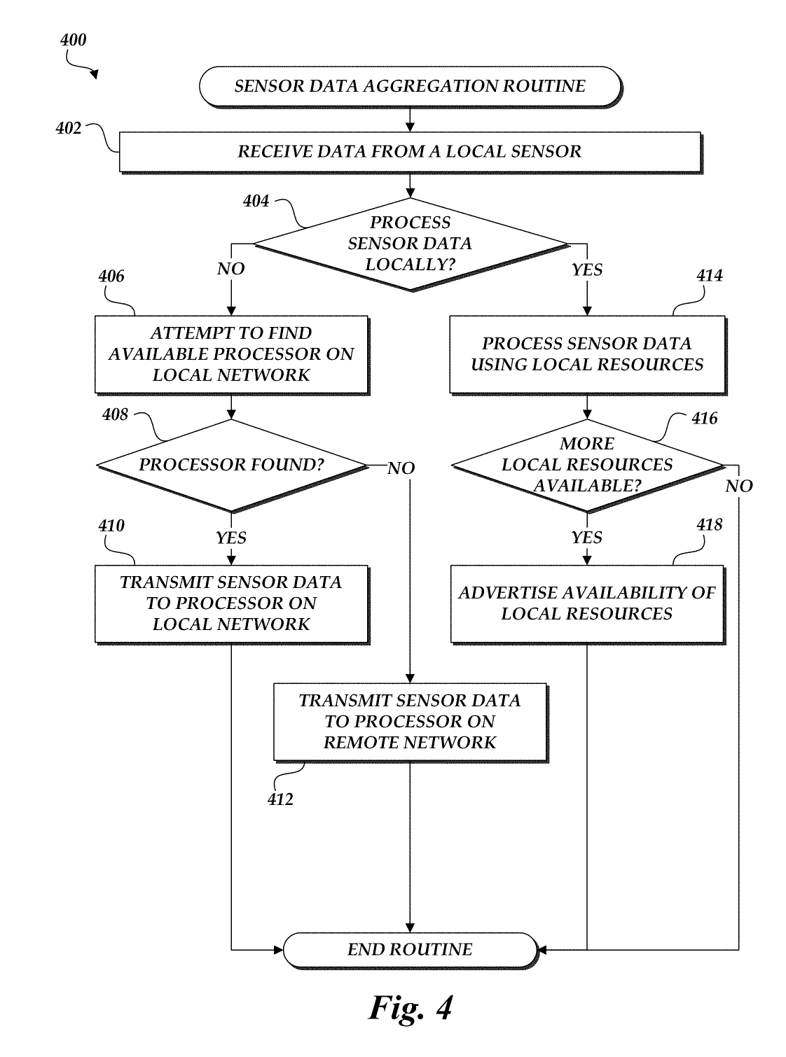

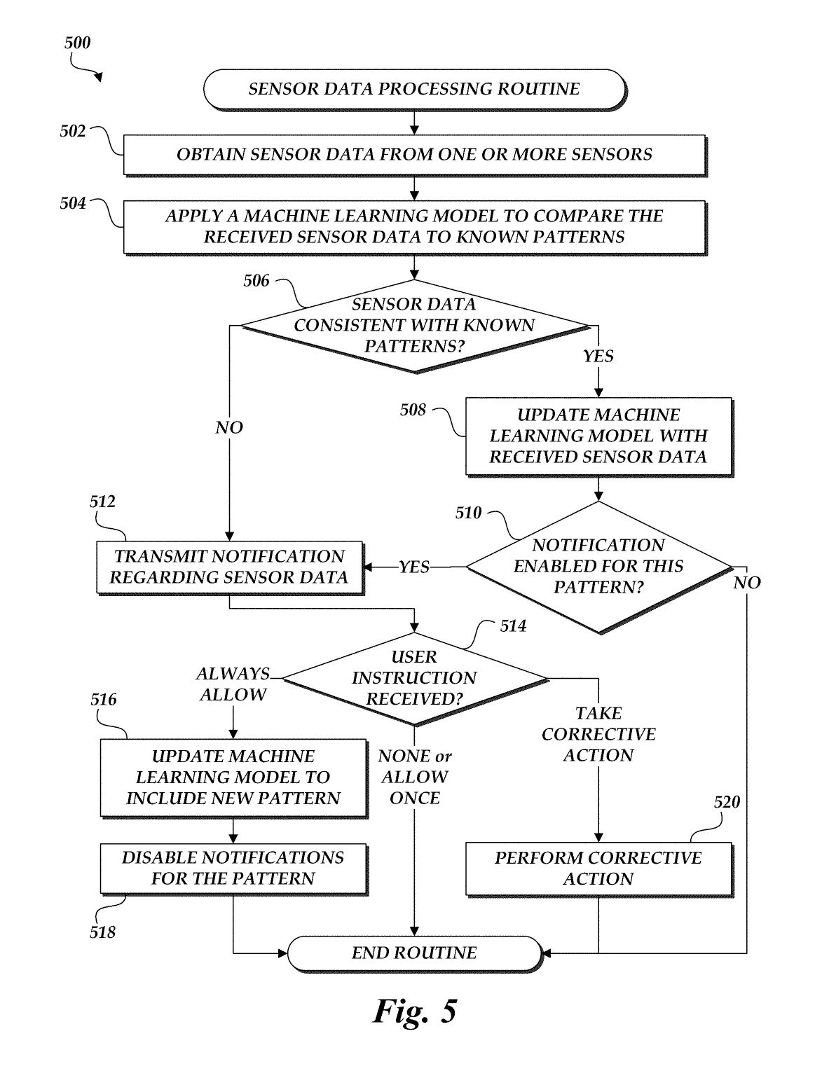

In some embodiments, the memory 320 may include a sensor data aggregation module 324, which may be executed by the processor 302 to perform various operations, such as those operations described with reference to FIG. 4 below. The memory 320 may further include a sensor data processing module 142, which may perform operations such as those described with reference to FIG. 5 below. The memory 320 may still further include machine learning models 326 that are obtained from the data store 308 and loaded into the memory 320 as various operations are performed. The memory 320 may still further include sensor data 330 that are collected from the sensor 304 (or, in some embodiments, from another sensor data processing module 142 via the network interface 306) and loaded into the memory 320 as various operations are performed.

While the operating system 322, the sensor data aggregation module 324, and the sensor data processing module 142 are illustrated as distinct modules in the memory 320, in some embodiments, the sensor data aggregation module 324 and the sensor data processing module 142 may be incorporated as modules in the operating system 322 or another application or module, and as such, separate modules may not be required to implement some embodiments. In some embodiments, the sensor data aggregation module 324 and the sensor data processing module 142 may be implemented as parts of a single application.

The autonomous sensor device 112 may connect to one or more networks via the network interface 306. The network may be any wired or wireless network, including but not limited to a local area network (LAN), wide area network (WAN), mesh network, cellular telecommunications network, the Internet, or any other public or private communications network or networks. In some embodiments, the network interface 306 may utilize protocols such as WiFi, Bluetooth, LTE, GPRS, TCP/IP, UDP, Ethernet, or other protocols to communicate via the network(s).

It will be recognized that many of the components described in FIG. 3 are optional and that embodiments of the autonomous sensor device 112 may or may not combine components. Furthermore, components need not be distinct or discrete. Components may also be reorganized. For example, the autonomous sensor device 112 may be represented in a single physical device or, alternatively, may be split into multiple physical devices. In some embodiments, components illustrated as part of the autonomous sensor device 112 may additionally or alternatively be included in other computing devices (e.g., the sensor data processing device 114, networked computing device 140, or mobile computing device 150), such that some aspects of the present disclosure may be performed by the autonomous sensor device 112 while other aspects are performed by another computing device.

FIG. 4 is a flow diagram of an illustrative sensor data aggregation routine 400. The sensor data aggregation routine 400 may be carried out, for example, by the sensor data aggregation module 324 of FIG. 3 or the sensor data processing device 114 of FIG. 1. At block 402, in some embodiments, sensor data may be obtained from a local sensor. In other embodiments, as described above, sensor data may be obtained via a network interface.

At decision block 404, a determination may be made as to whether the sensor data obtained at block 402 should be processed locally, or whether the obtained sensor data should be transmitted to another device for processing. For example, the routine 400 may communicate with other sensor devices on a local network to identify a lead sensor device, and the determination may then be to transmit sensor data to the lead sensor device. In some embodiments, a determination of available processing power, memory, or other computing resources may be compared to an estimate of the resources required to process the sensor data, and a determination may be made based on whether local resources are sufficient. In some embodiments, processing estimates may be based on processing of previously obtained sensor data. The determination may also consider whether the sensor data can be processed locally or remotely in a timely fashion. For example, a determination may be made as to whether the sensor data can be processed within a specified time interval.

If the determination is that the sensor data is to be processed locally, then at block 414 the sensor data may be processed using the available local resources. Illustratively, the sensor data may be processed by carrying out a routine such as the sensor data processing routine 500, which is described in more detail below with reference to FIG. 5.

In some embodiments, a determination may be made at decision block 416 as to whether excess local resources are available for use in the processing of sensor data. Illustratively, the local resources available for sensor data processing may be more than sufficient to process the sensor data that is being generated locally. The routine 400 may thus determine that local resources are available for processing of sensor data from other sources. It will be understood that “local” in this context may refer to other sensors or devices on a local network, such as the local network 120 of FIG. 1.

If the determination at decision block 416 is that local resources are available, then at block 418 the availability of local resources may be advertised. For example, a message may be sent on a local network to inform other devices or sensors on the network that the local resources are available. In some embodiments, a response may be sent to a general or specific request for processing resources. The message or response may specify the resources that are available, a quantity or type of sensor data that can be processed, or other information. If the determination at decision block 416 is that additional resources are not available, then the routine 400 ends.

If the determination at block 404 is that the available local resources are insufficient to process the sensor data obtained at block 402, then the routine 400 branches to block 406, where an attempt may be made to find an available processor on the local network. As described above, the routine 400 may transmit or broadcast a request on the local network seeking available processing resources, or may receive (and, in some embodiments, store) resource availability information sent from other devices on the local network.

At decision block 408, a determination may be made as to whether a processor on the local network is available to process the sensor data. If so, then at block 410 the sensor data may be transmitted to the available processor on the local network. If no processor is available on the local network, then at block 412 the sensor data may be transmitted to a processor on a remote network. Illustratively, the sensor data may be transmitted to a computing device such as the networked computing device 140 or mobile computing device 150 of FIG. 1, and may be transmitted via a network such as the external network 130 of FIG. 1.

In some embodiments, the search for an available processor at block 406 may not be limited to any particular network. For example, as described above, in some embodiments the autonomous sensor devices and any remote computing devices may communicate with each other via a single network, and the search for available processors may include both local and remote devices. In other embodiments, a further search may be required to identify whether a remote processor is available. For example, an attempt may be made to locate a computing device associated with the owner of the vehicle (such as the mobile computing device 150 of FIG. 1), and to offload processing of sensor data to the owner's computing device. In other embodiments, sensor data may be stored until local processing resources or a remote processor becomes available. The blocks of routine 400 may thus be varied, combined, or separated within the scope of the present disclosure.

FIG. 5 is a flow diagram of an illustrative sensor data processing routine 500. The routine 500 may be carried out, for example, by the sensor data processing module 142 of FIG. 3, or by the sensor data processing device 114, autonomous sensor devices 112A-C, or sensor data processing modules 142A-B of FIG. 1. At block 502, sensor data may be obtained from one or more sensors. In some embodiments, sensor data may be obtained as a result of carrying out a routine, such as the sensor data aggregation routine 400 of FIG. 4.

At block 504, a machine learning model may be applied to the sensor data to determine an event or possible event from the set of sensor data. For example, a machine learning model may be applied to data from an external microphone and a lateral motion sensor, and may identify a pattern from the set of sensor data consistent with another vehicle denting the rear fender of the vehicle. As a further example, a machine learning model may be applied to data obtained from a pressure sensor, a motion sensor, and a camera, and may identify a pattern that is consistent with a person entering the vehicle and sitting in the driver's seat. In some embodiments, the machine learning model may identify characteristics of the person (e.g., height, weight, facial features, an identifier associated with a mobile computing device, etc.) and use them to determine whether the person corresponds to a known driver or passenger. In further embodiments, the machine learning model may be trained on a variety of sensor data patterns, including general patterns (e.g., a person entering the vehicle and sitting in the driver's seat) and specific patterns (e.g., the facial features and other identifiers associated with a specific person). The machine learning model may thus identify multiple patterns or combinations of patterns that are consistent with the sensor data. For example, the machine learning model may determine that a person whom the model has been trained to recognize is sitting in the left rear passenger seat. As a further example, the machine learning model may determine that a person is sitting in the driver's seat, but that the sensor data associated with the person does not correspond to any data set the model has been trained to recognize.

At decision block 506, a determination may be made as to whether the output from the machine learning model indicates that the sensor data corresponds to a routine or non-routine pattern. Illustratively, the determination may be that the sensor data corresponds to a pattern that is known and safe (e.g., a driver profile of a known driver), to a pattern that is known and unsafe (e.g., an approaching emergency vehicle, a collision with another vehicle, a high temperature reading in a vehicle containing a small child or an animal, etc.), or to an unknown pattern (e.g., an unrecognized driver or passenger). In some embodiments, blocks 504 and 506 may be combined, and the machine learning model may both identify the pattern and determine the category it falls into. For example, the machine learning model may use a decision tree, set of rules, or other criteria to classify the patterns it recognizes, and may determine based on these criteria that the pattern it has recognized (or not recognized) should cause a notification to be transmitted.

If the determination at decision block 506 is that the pattern is a known and safe pattern, then at block 508, in some embodiments, the machine learning model may be updated or retrained to include the sensor data received at block 502. In other embodiments, block 502 may be omitted or carried out independently of the routine 500. For example, the machine learning model may be periodically retrained on recently received sensor data, or may be retrained if its pattern detection accuracy (as measured by, e.g., a percentage of false positives or misidentifications) falls below a threshold.

At decision block 510, a determination may be made as to whether notifications are enabled for the pattern identified at block 504. If so, or if the determination at block 506 is that the pattern is not a known and safe pattern, then at block 512 a notification may be generated and transmitted regarding the pattern. If the determination at decision block 510 is that notifications are not enabled for this pattern, then the routine 500 ends. The notification at block 512 may illustratively be an alert or notification as shown in FIGS. 2A-2D.

At decision block 514, a determination may be made as to whether a recipient of the notification has sent a request or instruction regarding the notification. If not, or if the instruction is that no action should be taken, then the routine 500 ends. If instead the instruction is that a notification should not be transmitted in this instance (either because the recipient recognizes the unknown pattern as a safe pattern, or because the recipient no longer wishes to receive notifications regarding a known/safe pattern), then at block 516 the list of known/safe patterns may optionally be updated to include the pattern. In embodiments in which decision block 510 is reached, the list of known/safe patterns may already include the pattern identified at block 504, and block 516 may thus be omitted. At block 518, notifications may be disabled for the pattern.

If the instruction received at block 514 is to take a corrective action, then at block 520 a corrective action or actions may be performed. As described above, a corrective action may correspond to a type or category of the unknown pattern. For example, if the unknown pattern corresponds to an unknown driver, then the corrective action may be to report the vehicle stolen or disable the engine. As a further example, if the pattern corresponds to a known and unsafe pattern (e.g., another vehicle colliding with the vehicle), then the corrective action(s) may be to generate an insurance claim and preserve the sensor data.

In various embodiments, the blocks of routine 500 may be combined, separated, or carried out in different orders. For example, blocks 516 and 518 may be combined or carried out in either order. As a further example, block 508 may be carried out after block 510, or may only be carried out in response to particular user instructions. In other embodiments, the routines 400 and 500 may be combined into a single routine, or the blocks of the routines 400 and 500 may be combined in different ways. For example, the list of known/safe patterns may be centralized in a particular device, such as the sensor data processing device 114 of FIG. 1, and individual devices may identify and transmit a pattern to the sensor data processing device 114, which may then in turn determine whether the pattern is a known/safe pattern.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

What is claimed is:

1. A system comprising:
a vehicle equipped with one or more sensors;
a data store configured to store computer-executable instructions, previously collected sensor data, and one or more known driver profiles; and
a processor in communication with the data store and the one or more sensors, wherein the computer-executable instructions, when executed by the processor, configure the processor to:
obtain sensor data from the one or more sensors;
process the sensor data with a machine learning model, wherein the machine learning model is trained according to one or more known driver profiles;
generate a notification message regarding the sensor data based at least in part on machine learning model output indicating that the sensor data does not correspond to the one or more known driver profiles; and
cause transmission of the notification message to a client computing device.

2. The system of claim 1, wherein the processor is further configured to:
receive, from the client computing device, a request to perform a corrective action with regard to the sensor data; and
cause performance of the corrective action.

3. The system of claim 2, wherein the corrective action comprises at least one of reporting the vehicle as stolen, disabling the vehicle, tracking the vehicle, triggering an alarm on the vehicle, storing the sensor data in the data store, transmitting the sensor data to a third party, or notifying an insurance provider.

4. The system of claim 1, wherein the processor is further configured to:
receive, from the client computing device, a request to generate a driver profile that corresponds to the sensor data;
generate the driver profile based at least in part on the sensor data; and
store the driver profile in the data store as an update to the one or more known driver profiles.

5. The system of claim 1, wherein the sensor data comprises at least one of audio, video, pressure, motion, temperature, geolocation, date, time, or a wireless signal.

6. A computer-implemented method comprising:
under control of a computing device executing specific computer-executable instructions,
obtaining sensor data from one or more sensors associated with a vehicle;
generating a notification message regarding the sensor data based at least in part on processing the sensor data with a machine learning model trained to recognize one or more sensor data patterns; and
transmitting the notification message to a client computing device.

7. The computer-implemented method of claim 6 further comprising:
designating a computing device to process the sensor data from the one or more sensors.

8. The computer-implemented method of claim 7, wherein the computing device to process the sensor data is designated based at least in part on a comparison of resources of the computing device to resources of the one or more additional computing devices.

9. The computer-implemented method of claim 6, wherein the one or more sensors comprise at least one of a motion sensor, pressure sensor, audio sensor, temperature sensor, geolocation sensor, or camera.

10. The computer-implemented method of claim 6, wherein the sensor data comprises at least one of height data, weight data, facial recognition data, voice recognition data, movement data, temperature data, time of day, day of week, geolocation data, or detection of a mobile computing device or wearable computing device.

11. The computer-implemented method of claim 6, wherein the sensor data corresponds to at least one of a driver, a passenger, a pedestrian, a nearby vehicle, an emergency vehicle, or an animal.

12. The computer-implemented method of claim 6, wherein the sensor data corresponds to at least one of lateral movement of the vehicle, proximity to the vehicle, a low or high temperature, a siren, entering or leaving a geographic area, an unknown driver, or an unknown passenger.

13. The computer-implemented method of claim 6 further comprising:
obtaining a second set of sensor data from the one or more sensors;
determining to send a notification regarding the second set of sensor data based at least in part on obtaining a notification preference and processing the second set of sensor data with the machine learning model;
generating a second notification message regarding the second set of sensor data; and
transmitting the second notification message to the client computing device.

14. The computer-implemented method of claim 13 further comprising:
receiving, from the client computing device, a request to discontinue notifications regarding the second set of sensor data; and
updating the one or more sensor data patterns to include the second set of sensor data.

15. A non-transitory, computer-readable storage medium storing computer-executable instructions that, when executed by a computer system, configure the computer system to perform operations comprising:
processing a set of sensor data with a machine learning model to generate an output set corresponding to a set of training patterns regarding events;
processing the output set according to one or more business rules; and
transmitting a notification to a computing device regarding the sensor data.

16. The non-transitory, computer-readable storage medium of claim 15, wherein the one or more sensors are associated with at least one of a vehicle, nursery, hospital, bank, vault, supply room, or article of furniture.

17. The non-transitory, computer-readable storage medium of claim 15, the operations further comprising:
processing a second set of sensor data with the machine learning model generate a second output set corresponding to the set of training patterns; and
granting temporary access to a resource based at least in part on the second output set.

18. The non-transitory, computer-readable storage medium of claim 17, wherein the second output set corresponds to an authorized user of the resource.

19. The non-transitory, computer-readable storage medium of claim 15, the operations further comprising designating a computing device to process the sensor data.

20. The non-transitory, computer-readable storage medium of claim 15 further comprising:
generating a first training pattern based at least in part on the sensor data; and
updating the set of training patterns to include the first training pattern.
